(19) United States
(12) Patent Application Publication
(10) Pub. No.: US 2025/0350634 A1
(43) Pub. Date: Nov. 13, 2025

(54) System and Method for Surfacing Cyber-Security Threats with a Self-Learning Recommendation Engine

(71) Applicant: Google LLC, Mountain View, CA (US)

(72) Inventor: Awalin Nabila Sopan, Reston, VA (US)

(21) Appl. No.: 19/274,094

(22) Filed: Jul. 18, 2025

Related U.S. Application Data
(63) Continuation of application No. 18/305,898, filed on Apr. 24, 2023, now Pat. No. 12,388,865.
Application No. 18/305,898 is a continuation of application No. 16/588,967, filed on Sep. 30, 2019, now Pat. No. 11,637,862.

(51) Int. Cl. H04L 9/40; G06F 11/32; G06F 18/24; G06N 20/00

(52) U.S. Cl. CPC H04L 63/1466; G06F 11/327; G06F 18/24; G06N 20/00

(57) ABSTRACT

Techniques for performing cyber-security alert analysis and prioritization according to machine learning employing a predictive model to implement a self-learning feedback loop. The system implements a method generating the predictive model associated with alert classifications and/or actions which automatically generated, or manually selected by cyber-security analysts. The predictive model is used to determine a priority for display to the cyber-security analyst and to obtain the input of the cyber-security analyst to improve the predictive model. Thereby the method implements a self-learning feedback loop to receive cyber-security alerts and mitigate the cyberthreats represented in the cybersecurity alerts.

### PRIORITY CLAIM

The present application is a continuation of U.S. application Ser. No. 18/305,898 having a filing date of Apr. 24, 2023, which is a continuation of U.S. application Ser. No. 16/588,967 having a filing date of Sep. 30, 2019, now issued as U.S. Pat. No. 11,637,862. Applicant claims priority to and the benefit of each of such applications and incorporate all such applications herein by reference in its entirety.

### FIELD OF THE INVENTION

The present disclosure relates, generally, to cyber-security and more specifically to techniques to facilitate the analysis and remediation of cyberattacks.

### BACKGROUND

Cyber-security threats are a major risk to enterprises and individuals alike. Enterprises rely on security operations centers (“SOC”) and the analysts operating SOCs, to identify, respond to, and mitigate the consequences of cyber-security threats targeting the enterprise's systems. SOC analysts are inundated with cyber-security alerts received from a variety of cyber-security products deployed to protect an enterprise. To reduce the vast volume of alerts to be addressed by SOC analysts, some SOCs filter alerts (e.g., for duplicates, known false positives, and low priority alerts, etc.) before they are presented to a SOC analyst.

### BRIEF DESCRIPTION OF THE FIGURES

Embodiments of the disclosure are illustrated by way of example and not by way of limitation in the figures of the accompanying drawings, in which like references indicate similar elements and in which:

FIG. 1 is an exemplary block diagram of an automated analyst alerting system communicatively coupled to one or more cyber-security devices via a communication network, in accordance with an embodiment of the invention.

FIG. 2 illustrates a logical representation of the automated analyst alerting system of FIG. 1.

FIG. 3 is an exemplary flowchart of the operations of the automated analyst alerting system of FIGS. 1 and 2.

### DETAILED DESCRIPTION

The detailed description below, describes a technology wherein a cyber-security automated analyst alerting system receives one or more cyber-security alerts, the alerts are analyzed by an alert recommendation engine which automatically determines a recommended course of action related to the one or more received cyber-security alerts by application of a predictive machine learning model generated by a predictive machine learning logic (or predictive model generation logic). The predictive machine learning logic generates a machine learning model (or more simply, “model”), for use by the alert recommendation engine, in response to changes in a knowledge store. More specifically, to automatically determine a recommended course of action (i.e. a set of one or more instructions, or commands, issued by the described system to mitigate a cyber-security threat), the alert analysis and labeling engine generates a modified alert including at least one classification, classification confidence level, and contextual data for each alert according to the predictive machine learning model, to create a modified alert which are provided to the action generator. The action generator (or in some embodiments through the execution of an engine processing a separate action predictive machine learning model) determines a recommended course of action according to the predictive machine learning model and generates a signal through a reporting logic to present the modified alert for display to an analyst.

More specifically, the automated analyst alerting system (“AAAS”) is configured to receive an alert (the received alert is received from one or more alert-generating cyber-security devices), analyze the alert according to a model generated by a machine learning procedure applied to data in a knowledge store. The knowledge store includes data that associates previously detected alerts, cyber-security threats, and undesirable computing device configurations with one or more classifications as determined by a cyber-security analyst. Such classifications may include labels (e.g., “malicious”, “non-malicious”, “phishing”, “misconfiguration”, etc.) and a confidence level associated with the classification. For example, a received cyber-security alert received by the system and analyzed by the AAAS may classify the alert as “malicious” with a 17% confidence level, “non-malicious” with an 89% confidence level, and “misconfiguration” with a 91% confidence level. The classifications and their associated confidence levels are provided with the received alert, as well as with additional context related to the received alert, to create a modified alert and are provided to an action generator. The additional context may be based on prior selections of analysts, the prior selections stored in a knowledge store, and/or prior selections made by an expert system configured to make recommended actions based on associated received alerts. The knowledge store may be located locally and/or remotely via a network connection. In some embodiments the additional context may include information generated by the AAAS identifying a set of prior alerts (e.g., stored in the knowledge store) as being associated with a received alert and thereby identifying an advanced persistent cyber-security threat (i.e. a prolonged and targeted cyberattack in which an intruder may repeatedly attempt to gain access to a targeted network, computing device or user thereof). Based on the persistent cyber-security threat, the AAAS may modify the classifications and/or further classify the received alert as associated with the persistent cyber-security threat.

The predictive machine learning logic is configured to generate a predictive model based on data stored in the knowledge store. The data stored in the knowledge store may include the classifications associated with alerts that were previously received and classified (confirmed or reclassified) by cyber-security analysts. The knowledge store may also store mitigative actions selected by and/or input by a cyber-security analyst. The knowledge store may also be used to store meta-information associated with the success or failure of automated or manually selected mitigations and consequently create a self-learning feedback loop. The self-learning feedback loop surfaces classifications and actions for the cyber-security analysts.

The predictive machine learning logic may be co-located with the alert recommendation engine and/or remotely located. The predictive machine learning logic generates a predictive model according to conventional machine learning techniques (e.g., support vector machines, artificial neural networks, etc.) applied to the data stored in the knowledge store, in a process known as “training”. The training system may include information extracted from received alerts and stored as data in the knowledge store. The information extracted from the received alert may include received alert message content as well as well as meta-information associated with the received alert (e.g., time of receipt, IP address of the source cyber-security device, etc.). The training system may also include information associated with the received alert (e.g., modifying a label associated with alert or associating a course of action with the alert) by the cyber-security analyst and stored in the knowledge store. Based on information stored in the knowledge store, the predictive machine learning logic may generate the predictive model which, when applied to a received alert, may be used to classify and determine one or more courses of action related to the received alert using machine learning.

In some embodiments, the generated predictive model may be used by one or more classifiers to determine a probability of the accuracy (i.e. confidence level) of a label for each alert. The classifiers may classify each alert based on a label as determined by an analyst and/or the alert recommendation engine according to the predictive model. In some embodiments, analysts may select from a pre-defined set of labels, whereas, in other embodiments, labeling may be done automatically. A classifier may generate a probability of association with a label relating to each received alert.

Upon receipt of new data in the knowledge store, or periodically or aperiodically to account for any such newly stored data, the predictive machine learning logic generates a new predictive model by analyzing the data to determine associative relationships. In some embodiments, the application of a predictive model to a received alert may generate one or more labels and/or courses of actions, each associated with a confidence level. The confidence levels are correlated with a likelihood of the alert being associated with the label and/or course of action. The newly generated predictive model may be based on additional data—e.g., verification of a prior classification (e.g., of a classification made by the alert recommendation engine and, in some embodiments confirmed by the analyst), newly associated courses of actions (i.e. mitigative actions responsive to a received alert), where the association may be made automatically or made or confirmed by an analyst, and/or new information associated with alert classification provided to the knowledge store via an update mechanism. The newly generated predictive model is applied to newly received alerts by the alert recommendation engine for classification, thereby creating a self-learning feedback loop. The classification is responsive to the labels resulting from application of the predictive model to the received alert.

The action generator receives the modified alerts and associated context information to determine a recommended course of action for presentation via the reporting logic. The action generator determines a recommended course of action based on the application of a predictive model generated by the predictive model generation logic. The received modified alerts are analyzed by the action generator to determine a priority for presentation to an analyst. To determine a priority associated with the modified alert, the action generator may analyze the confidence levels (e.g., associated with a course of action determined by application of the predictive model, associated with a classification label, etc.). The priority assigned to a received alert may be based, at least in part, on a numerical distance of the confidence level a threshold, such as, for example, an automated execution threshold. For example, if the confidence associated with an action is 55% and the confidence threshold for automated execution of an action is 90%, the action generator may determine that the confidence associated with an action is too far from the threshold to be automatically actionable and should be displayed to an analyst and therefore given a higher priority for the analyst's attention. Similarly, if the confidence if the confidence associated with an action is 85% and the confidence threshold for automated execution of an action remains 90%, the action generator may determine that the confidence associated with an action is near the threshold, however, because it is not above the automatically actionable threshold, the received alert should be displayed to an analyst and therefore given a lesser priority than in the prior example. If a cyber-security threat or serious configuration issue requiring mitigation is detected (e.g., based on a classification and/or course of action), the action generator may determine whether the mitigation requires analyst attention (e.g., for selection) or if a recommended course of action may be automatically processed. To determine if analyst attention is required, the action generator determines if a course of action from the knowledge store and/or the expert system is applicable. A course of action is applicable if the action generator determines a level of correlation (i.e. confidence level) between a course of action and the modified alert exceeds a confidence threshold. If a course of action is automatically executed and fails to resolve the alert, the system may provide the modified alert associated with the failed action to the reporting logic for display to the analyst. If the action generator receives an alert associated with a persistent cyber-security threat, it may assign a priority to the modified alert and provide the priority to the presentation logic for display to an analyst. The action generator provides a further modified alert, the further modified alert combining the modified alert received by the action generator with the resulting course of actions, if applicable.

The further modified alert is provided to the presentation logic for layout composition. A layout is the way in which the modified alerts are composed for further review by the analyst. In some embodiments the layout may be composed for presentation to an analyst, in different layouts, according to the analyst's role. In some embodiments the modified alert may be presented to the analyst in different windows or otherwise highlighted, according to the assigned priority.

The presentation logic receives the further modified alert to determine if the further modified alert is to be presented to an analyst for further review. The presentation logic may determine, based on the assigned priority of the further modified alert, to present the further modified alert to a cyber-security analyst. The presentation logic may determine, that a further modified alert shall not be presented to the cyber-security analyst due the relative priority (e.g., lesser) compared to other further modified alerts presented to the analyst at the same time. The relative priority of a further modified alert may increase (or decrease) based on selections made by a cyber-security analyst (e.g., as an analyst processes and addresses a first further modified alert, the relative priority of other further modified alerts may increase and be presented to the analyst).

The presentation logic may also process the course of action data included in the further modified alert to determine if a course of action may be automatically executed. A course of action to be automatically executed may be identified by the further modified alert. Automatic execution of the course of action may require communication with a conventional external computing device that is configured to effectuate the course of action (e.g., a firewall, switch, server or endpoint system) connected to the network via the network interface. The mitigation logic receives a course of action for processing, the course of action may be received via the presentation logic if automatically selected or via an analyst interface when selected by an analyst. The mitigation logic initiates an external computing device (e.g., a cyber-security device, etc.) to execute a mitigation (i.e. via a course of action) sent by the mitigation logic.

More specifically, the mitigation logic processes the course of action received and launches processes based on the course of action. The executed course of action includes at least one process to be executed. Some processes to be executed as a course of action may require communication with one or more external computing devices through an interface (e.g., API calls to external computing devices, etc.). In some embodiments, courses of action may include more than one process, each process may be required by the course of action to be processed in series or parallel (in a temporally overlapping manner). A process may be required to be executed in series if the output of a first process is required as input of a subsequent process. If a process of the course of action executed does not process successfully, an alert may be generated by the mitigation logic and provided to the presentation logic for display to the cyber-security analyst. For example, a course of action may require a process A and a process B to operate in series. Process A may include the execution of an API call to a network connected firewall requesting the status of port 8081, while Process B executes a process receiving the status, and if the status is “open”, executes an API call to the network connected firewall to close port 8081. Based on the success of the execution of the processes of the course of action, the mitigation logic communicates to the presentation logic. In some embodiments, the mitigation logic may provide an error message to the presentation logic, describing the nature of the failure if the course of action did not successfully complete. The meta-information associated with the processing by the mitigation logic (e.g., error messages, process success or failure, course of action success or failure, etc.) is provided in the form of an execution message. The mitigation logic may be configured to automatically, manually, or semi-automatically process courses of action.

The presentation logic receives data associated with the processing of a course of action by the mitigation logic (i.e. an execution message), via the mitigation logic. The data included in the received execution message is associated with the further modified alert and a determination is made by the presentation logic to present to an analyst. For example, the analyst may be provided a notification of a successful (or failed) execution of a course of action. In some embodiments an analyst may be presented with an alert describing the failed execution of a course of action as well as the associated further modified alert. The presentation logic provides the further modified alert to the storage logic for further processing.

The storage logic receives the further modified alert, from the presentation logic, and the associated execution message, and determines if the content received (e.g., the data associated with the further modified alert obtained from the execution message) should be stored in the knowledge store. The further modified alert may contain information about selections and results of course of action selected by an analyst and/or automatically selected by the presentation logic. The storage logic may parse the further modified alert to extract the selection of a course of action by an analyst to store in the knowledge store. In some embodiments, the storage logic may determine that a selected course of action need not be stored in the knowledge store based on the success and/or failure of the course of action. In some other embodiments an execution message may be received directly from the mitigation logic, instead of being received via the presentation logic. Once processed by the storage logic, the presentation alert is provided to the reporting engine for display to the analyst.

The reporting logic is configured to provide reports via an interface to an analyst and/or a system administrator. The reporting logic may provide reports via an analyst interface and/or a network interface. The reporting logic generates the report for the analyst based on information provided by a received further modified alert. The reporting logic may be configured to generate discrete reports and/or dynamic interfaces for interaction by an analyst. The further modified alert to be displayed by the reporting interface, in combination with the system interface, may be displayed in addition to other further modified alerts that have been received by a dynamic interface. The analyst may interact with each further modified alert for analysis of the alert using additional information provided by the system and/or to select a course of action (which may also be included in the further modified alert). The interaction with the further modified alert may be received by an interface (e.g., a network interface and/or the analyst interface). The information received by the interface may be provided to the knowledge store via the storage logic. The information stored in the knowledge store is used by the predictive machine learning logic to generate a predictive model to implement a self-learning feedback loop. The self-learning feedback loop aids an analyst in efficiently addressing cyber-security alerts received by a cyber-security automated analyst alerting system.

Elements of the invention employ computerized techniques to generate machine learning models used to classify received alerts, initiate the display of classified received alerts, and re-generate the machine learning models in response to input receive from a cyber-security analyst responsive to the displayed classified received alert.

### I. Terminology

In the following description, certain terminology is used to describe features of the invention. For example, in certain situations, both terms “logic” and “engine” are representative of hardware, firmware and/or software that is configured to perform one or more functions. As hardware, logic (or engine) may include circuitry having data processing or storage functionality. Examples of such circuitry may include, but is not limited or restricted to a microprocessor, one or more processor cores, a programmable gate array, a microcontroller, an application specific integrated circuit, wireless receiver, transmitter and/or transceiver circuitry, semiconductor memory, or combinatorial logic.

Logic (or engine) may be software in the form of one or more software modules, such as executable code in the form of an executable application, an application programming interface (API), a subroutine, a function, a procedure, an applet, a servlet, a routine, source code, object code, a shared library/dynamic load library, or one or more instructions. These software modules may be stored in any type of a suitable non-transitory storage medium, or transitory storage medium (e.g., electrical, optical, acoustical or other form of propagated signals such as carrier waves, infrared signals, or digital signals). Examples of non-transitory storage medium may include, but are not limited or restricted to a programmable circuit; a semiconductor memory; non-persistent storage such as volatile memory (e.g., any type of random access memory “RAM”); persistent storage such as non-volatile memory (e.g., read-only memory “ROM”, power-backed RAM, flash memory, phase-change memory, etc.), a solid-state drive, hard disk drive, an optical disc drive, or a portable memory device. As firmware, the executable code is stored in persistent storage. The term “computerized” generally represents that any corresponding operations are conducted by hardware in combination with software and/or firmware.

The term “transmission medium” (or “transmission media”) may refer to a communication path between two or more systems (e.g. any electronic devices with data processing functionality such as, for example, a security appliance, server, mainframe, computer, netbook, tablet, smart phone, router, switch, bridge or router). The communication path may include wired and/or wireless segments. Examples of wired and/or wireless segments include electrical wiring, optical fiber, cable, bus trace, or a wireless channel using infrared, radio frequency (RF), or any other wired/wireless signaling mechanism.

The term “alert” may refer to a signal or notification (e.g., report) received from, or issued by, a source. The alert conveys information regarding an event. An event may refer to an observed (or in some cases, inferred) occurrence that has significance to an associated alert type. An alert type may indicate an alert classification (e.g., an alert indicating a user login attempt may be classified as a “user alert”—i.e. an alert with a “user” type). A cyber-security event may be relevant to a cyber-threat. Relationships between events may be determined based on information provided by received cyber-security alerts describing events monitored by the cyber-security devices (or software). For example, a user-operated endpoint may be monitored by resident cyber-security software (e.g., an embedded agent), the software monitoring the execution of a process “opening” a file. An alert may be associated with, or triggered by, any of a variety of computing activities, for example: a granting or denial of administrative rights or escalation of privileges, an unauthorized access of an access-restricted compute device, detection of a new device on a restricted network, multiple different user login(s) made by a single compute device, an unexpected/unusual login of a user, detection of an internal vulnerability, etc.

The term “message” generally refers to signaling (wired or wireless) as either information placed in a prescribed format and transmitted in accordance with a suitable delivery protocol or information made accessible through a logical data structure such as an API. Hence, each message may be in the form of one or more packets, frame, or any other series of bits having the prescribed, structured format.

The term “object” generally refers to a collection of data, such as a group of related packets associated with a request-response message pairing for example, normally having a logical structure or organization that enables classification for purposes of analysis. For instance, an object may be a self-contained element, where different types of such objects may include an executable file, non-executable file (such as a document or a dynamically link library), a Portable Document Format (PDF) file, a JavaScript file, Zip file, a Flash file, a document (for example, a Microsoft Office® document), an electronic mail (email), downloaded web page, an instant messaging element in accordance with Session Initiation Protocol (SIP) or another messaging protocol, or the like.

The term “appliance” refers to any type of general-purpose or special-purpose computer, including a dedicated computing device, adapted to implement any variety of existing, or future, software architectures relating to detection of, and protection from, cyberattack and related functionality. The term appliance should therefore be taken broadly to include such arrangements, in addition to any systems or subsystems configured to support such functionality, whether implemented in one or more network computing devices or other electronic devices, equipment, systems or subsystems.

The terms “computer”, “processor”, “computer processor”, “compute device”, or the like should be expansively construed to cover any kind of electronic device with data processing capabilities including, by way of non-limiting example, a digital signal processor (DSP), a microcontroller, a field programmable gate array (FPGA), an application specific integrated circuit (ASIC), a graphics processing unit (GPU), or any other electronic computing device comprising one or more processors of any kind, or any combination thereof.

As used herein, the phrase “for example,” “such as”, “for instance”, and variants thereof describe non-limiting embodiments of the presently disclosed subject matter. Reference in the specification to “one case”, “some cases”, “other cases”, or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

### II. Architecture

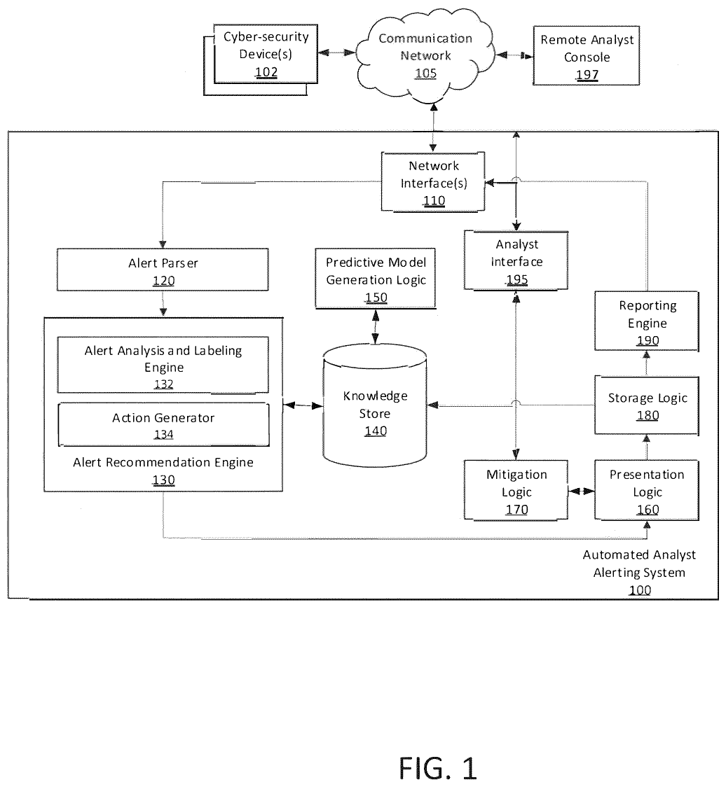

Referring to FIG. 1, an exemplary block diagram of an automated analyst alerting system 100 is communicatively coupled, via a network interface 110, to at least one communication network 105. The communication network 105 may couple the automated analyst alerting system 100 with cyber-security devices 102 and/or a remote analyst console 197 via transmission media to exchange information with the communication network directly or via the Internet. The communication network 105 may be coupled directly or indirectly to cyber-security device(s) 102. The cyber-security devices 102 may operate within the same or different networks. Each cyber-security device represents a logical entity, operating on objects, to determine if they represent a cyber-security risk. In some embodiments a cyber-security device 102 may include a software application operating on a user operated endpoint device (e.g., a laptop, mobile phone, etc.) while in some other embodiments the cyber-security device may include a dedicated cyber-security appliance. The cyber-security device 102 may detect potential cyber-security threats and generate and issue a cyber-security alert. The cyber-security device 102 may be configured to direct issued alerts to the automated analyst alerting system 100.

The automated analyst alerting system 100 includes a network interface 110, an alert parser 120, an alert recommendation engine 130, a knowledge store 140, a predictive model generation logic 150, a presentation logic 160, a mitigation logic 170, a storage logic 180 a reporting engine 190 and an analyst interface 195. Upon receipt by the automated analyst alerting system 100 of an alert generated by a cyber-security device 102, via the network interface 110, the alert is provided to the alert parser 120. The alert parser 120 analyzes the received alert and normalizes the contents according to a set of normalization rules that normalize the received alert into a known alert format, comprehensible by the alert recommendation engine 130. In some embodiments the normalization rules may be user-defined (and/or user-modifiable). In some embodiments the alert parser may be updated with additional (modified) processing (normalizing) rules. Such updates may be received by the automated analyst alerting system 100 periodically or aperiodically via the network interface 110. The rule update may be processed by the alert parser 120 directly or via a separate logic (not shown).

The alert parser 120 provides the normalized alert to the alert recommendation engine 130 for further analysis. In some embodiments, the alert parser 120 may, limit further analysis of an alert based on contextual information. If a received alert received by the alert parser 120 includes a classification of the alert the alert parser may provide the alert recommendation engine 130 with the received alert classification and the alert recommendation engine 130 may include this classification (in some embodiments this classification may be added to the modified received alert without a confidence level). Contextual information may include data with respect to available system resources (e.g., processor load, memory availability, etc.), quality of alerts from particular cyber-security devices 120 (e.g., information related to reliability of cyber-security alerts in identifying cyberthreats associated with a particular cyber-security device), duplication (i.e. information that associates a set of alerts identifying identical alerts from cyber-security devices and associates them together for de-duplication by the various logics of the automated analyst alerting system), etc. Analysis of contextual information may be performed by the alert parser 120 by evaluating normalization rules by the alert parser 120. By reducing the number of received alerts to be analyzed by the automated analyst alerting system 100, the system may aid an analyst focus on high value alerts.

The alert recommendation engine 130 includes at least an alert analysis and labeling engine 132 and an action generator 134. The alert recommendation engine 130 receives, from the alert parser 120, an alert transformed according to the normalization rules and via the alert analysis and labeling engine 132, generates at least one label associated with the alert as well as a confidence level associated with each label. The action generator 134 of the alert recommendation engine 130 receives the label and associated confidence levels from the alert analysis and labeling engine 132 and determines if an action may be associated with the alert. The components of the alert recommendation engine 130 (i.e. the alert analysis and labeling engine 132 and the action generator 134) operate in concert with information provided by the knowledge store 140.

The knowledge store 140, operating in concert with the alert recommendation engine 130, provides information generated from the predictive model generation logic 150 and information received from analyst operation. The information provided to the knowledge store 140 may include, by non-limiting example, information associated with execution of mitigations by cyber-security device(s) 102, information associated with the result of instructed mitigations by cyber-security device(s), classification of a received alert by an analyst, etc. Additionally, in some embodiments, the knowledge store 140 may include the predictive model generated by the predictive model generation logic 150. In some embodiments the predictive model may be stored in a separate store (e.g., a store provided by the alert recommendation engine 130, etc.). In some embodiments, the knowledge store 140 may receive and store information, from the analyst, associated with a classification of a received alert (e.g., related alerts, identifiers associated with the alert, intelligence associated with a received alert, etc.).

The predictive model generation logic 150 may periodically or aperiodically generate a predictive model to be used by the alert recommendation engine 130. The predictive model generation logic may generate the predictive model in response to the receipt of a signal indicating new information has been stored in the knowledge store 140. In some embodiments, the predictive model generation logic 150 may only generate a new model in response to the receipt by the knowledge store 140 of information received from an analyst (e.g., a new alert classification, a modification and/or update to an existing classification, correction of a previously mis-classified alert, etc.). The predictive model generated by the predictive machine learning model 150 may be generated according to a known machine learning recommendation techniques. In some embodiments the predictive machine learning logic 150 may train a predictive model based on the labelled data stored in the knowledge store 140. In some embodiments, the predictive machine learning logic 150 may generate the predictive machine learning model “offline” (i.e., “out of band”). In some embodiments (not shown) the predictive machine learning logic 150 may be remotely located from the automated analyst alert system 100 and communicatively coupled, for example, via communication network 105, with cloud computing resources (not shown). The generated predictive model generates at least one classification and/or association of the classification with an alert. In some embodiments the classification generated by the predictive model may correspond to a numerical association with the classification. For example, based on analysis of the alert by the predictive model generated by the predictive model generation logic 150, an alert may be associated with (a) maliciousness (31% confidence level), (b) phishing (51% confidence level), and (c) benign (67% confidence level).

In some embodiments, the predictive model generation logic 150 may generate a predictive model associating mitigation actions (“actions”) with identified classifications. In other embodiments, a separate logic (e.g., the action generator 134) may determine an action associated with identified classifications. A set of known actions may be stored in the knowledge store 140. In some embodiments, the analyst may generate (i.e. user-define) an action to be stored in the knowledge store. In certain embodiments, actions generated by an analyst, in response to an alert are automatically stored in the knowledge store 140.

The alert analysis and labeling engine 132 receives from the alert parser 120 the received alert for further analysis and obtains a predictive model from the knowledge store 140. The alert analysis and labeling engine 132 is configured to apply the obtained predictive model and apply the predictive model to the received alert. By applying the predictive model to the received alert the alert analysis and labeling engine 132 generates at least one classification label and confidence level. If a plurality of classification labels and levels of association of classifications are generated, the alert analysis and labeling engine 132 will determine a classification for the received alert. In some embodiments the alert analysis and labeling engine 132 may apply more than one classification to an alert. In some embodiments the classification determination of the alert analysis and labeling engine 132 may, by way of non-limiting example, include the classification corresponding to the highest confidence level, each classification where an associated level of classification exceeds a threshold, a classification associated with a level of classification exceeding a second threshold, higher than a first threshold, etc. In some embodiments the alert analysis and labeling engine 132 may provide the classification of the alert and the alert to the action generator 134 while in other embodiments, the alert analysis and labeling engine may provide the classification and the received alert directly to the presentation logic 160.

The action generator 134 is configured to analyze the received alerts and classification to determine if a known action may be recommended to a receiving analyst. In some embodiments, the predictive model generation logic 150 may generate a predictive action model, stored in the knowledge store 140. The predictive action model is adapted to, in combination with the action generator 134, associate a known action with a received alert. In other embodiments the action generator may be configured with a set of rules associating specified actions with selected alerts. For example, an alert received and classified by the alert analysis and labeling engine 132 as being associated with “phishing” may cause the action generator 134 to associate an action to the alert, the action, upon execution, quarantines the cyber-security device 102 associated with the alert (i.e. the computing device associated with the phishing alert). Rules to be processed by the action generator 134 may be factor-set, and/or user (e.g., security administrator, analyst, etc.) configurable. The action generator may rely on information processed by the alert parser 120 associated with affected devices protected by the automated analyst alerting system 100. In some embodiments the action generator 134 may identify an action associated with the alert to be automatically executed (e.g., not require execution approval from analyst). The action generator 134 may determine that no known (e.g., in the knowledge store 140, and/or in configured rules of the action generator) action may be associated with the received alert and classification. Once an alert is analyzed by the action generator 134, the alert is provided to the presentation logic 160.

The presentation logic 160 receives, from the alert recommendation engine 130, the received alert and associated classifications and actions. The presentation logic 160 determines if an associated action should be provided directly to the mitigation logic 170 or be presented to an analyst for determination. The presentation logic 160 may be configured to determine if and how an alert should be presented to an analyst by the reporting engine 190. The presentation logic 160 may determine an alert whose associated action is to be automatically executed by the mitigation logic 170 should be presented to the analyst despite its automated execution. In some embodiments the presentation logic 160 may generate a graphical user interface (GUI) for the reporting engine 190 to present to the analyst. The presentation logic 160 may receive results associated with the execution of an action by the mitigation logic 170 and/or instructions received from the analyst related to alerts that were presented to the analyst. The presentation logic 160 provides the received alert and associated results and/or analyst instruction to the storage logic 180.

The storage logic 180 determines if a received action, alert classification, or analyst instruction (e.g., action instruction, creation of a new action, etc.) should be stored in the knowledge store 140. The determination as to whether an action should be stored in the knowledge store 140 may be based on whether the action is duplicative (e.g., a similar action exists in the knowledge store), not in opposition to existing actions stored in the knowledge store, etc. In some embodiments, a modification to an existing action may be received by the storage logic 180 and the contents of the knowledge store 140 may be modified. If no action needs to be stored in the knowledge store 140 or if it has already been stored in the knowledge store, the received information is provided to the reporting engine 190 for presentation to the analyst.

The mitigation logic 170 receives from the presentation logic 160 actions for execution by cyber-security device(s) 102. The action generator 134 may identify, to the presentation logic 160 whether an action associated with an alert should be automatically executed by the mitigation logic. Similarly, the mitigation logic 170 may receive, via the network interface(s) 110, an action instruction from an analyst (e.g. via the analyst interface 195). The action instructed by the analyst to the mitigation logic 170 may be provided to the presentation logic 160 for further processing (as described above) and be further processed by the mitigation logic 170 for execution. The execution of actions by the mitigation logic 170 may be direct (e.g., an action which may be executed directly by the automated analyst system 100) or indirect (e.g., issuing instructions, via the network interface(s) 110 to cyber-security device(s) 102). In some embodiments the mitigation logic 170 may be configured with credentials for interaction with systems requiring authorization for executing cyber-security actions. The mitigation logic 170 may be configured to generate application programming interface (API) calls to cyber-security device(s) 102 in response to receiving an action for execution. In other embodiments an action may include the execution details and the mitigation logic 170 does not generate API calls to the cyber-security device(s) 102. The result of an execution is received by the mitigation logic 170 via the network interface(s) 110 and provided to the presentation logic 160.

The reporting engine 190 may be configured to generate an alert for transmission to an external display of an analyst. The reporting engine 190 may be configured to provide a GUI to the analyst display and/or other known display systems (e.g., command line terminal, etc.). The reporting engine 190 is configured to provide reports via the network interface(s) 110, for example, the remote analyst console 197. In some embodiments the reporting engine 190 may provide interactive alert which may allow an analyst to provide responsive instructions to the mitigation logic 170 for further processing by the automated analyst alerting system 100. The analyst may provide an interactive response and consume alerts via the remote analyst console 197.

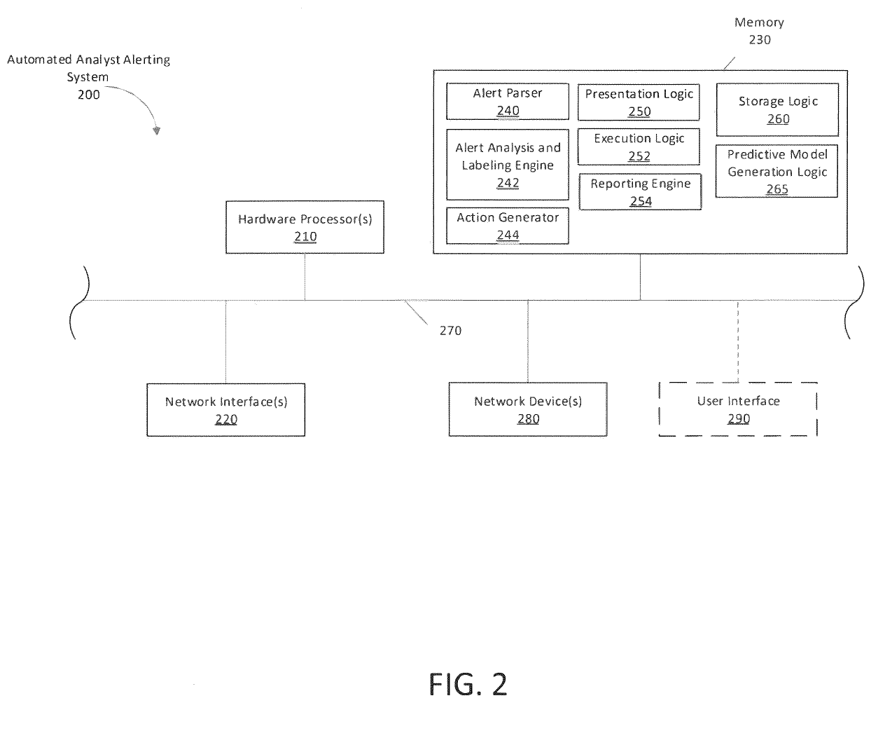

As illustrated in FIG. 2 in greater detail, the automated analyst recommendation system 200 has physical hardware including hardware processors 210, network interface(s) 220, a memory 230, a system interconnect 270, and optionally, a user interface 290. The memory 230 may contain software comprising an alert parser 240, an alert analysis and labeling engine 242, an action generator 244, presentation logic 250, a mitigation logic 252, a reporting engine 254, an storage logic 260, and a predictive model generation logic 265. The physical hardware (e.g. hardware processors 210, network interface(s) 220, memory 230) may be connected for communication by the system interconnect 270, such as a bus. Generally speaking, an automated analyst recommendation system 200 is a network-connected alert analysis system configured to enhance the operation of a security operations center (SOC) by providing a SOC analyst with relevant alerts and meta-information.

The hardware processor 210 is a multipurpose, programmable device that accepts digital data as input, processes the input data according to instructions stored in its memory, and provides results as output. One example of the hardware processor 210 is an Intel® microprocessor with its associated instruction set architecture, which is used as a central processing unit (CPU) of the automated analyst recommendation system 200. Alternatively, the hardware processor 210 may include another type of CPU, a digital signal processor (DSP), an application specific integrated circuit (ASIC), or the like.

The network device(s) 280 may include various input/output (I/O) or peripheral devices, such as a storage device, for example. One type of storage device may include a solid state drive (SSD) embodied as a flash storage device or other non-volatile, solid-state electronic device (e.g., drives based on storage class memory components). Another type of storage device may include a hard disk drive (HDD). Each network device 280 may include one or more network ports containing the mechanical, electrical and/or signaling circuitry needed to connect the automated analyst recommendation system 200 to the private network 120 to thereby facilitate communications over the communication network 105. To that end, the network interface(s) 220 may be configured to transmit and/or receive messages using a variety of communication protocols including, inter alia, TCP/IP and HTTPS.

The memory 230 may include a plurality of locations that are addressable by the hardware processor 210 and the network interface(s) 220 for storing software (including software applications) and data structures associated with such software. The hardware processor 210 is adapted to manipulate the stored data structures as well as execute the stored software, which includes an alert parser 240, an alert analysis and labeling engine 242, an action generator 244, presentation logic 250, an mitigation logic 252, a reporting engine 254, an storage logic 260, and a predictive model generation logic 265.

The alert parser 240 is a software application, operating on data (i.e. alerts) provided to the automated analyst recommendation system 200 via the network interface(s) 220 according to the description of alert parser 120 of FIG. 1. The alert parser 240 receives an alert and processes the alert according a set of normalization rules residing within the memory 230. The alerts processed by the alert parser 240 are provided to the alert analysis and labeling engine 242 for further processing.

The alert analysis and labeling engine 242 processes received alerts according to a generated predictive model stored in memory 230. The alert analysis and labeling engine generates a set of classifications in response to the processing of the received alert by the predictive model. The classifications may correspond to a set of labels applied to the received alert and to be used in further processing of the alert by other components of the automated analyst recommendation system 200. The classification labels generated by the alert analysis and labeling engine 242 may include a likelihood of association (i.e. confidence level) with the alert. The likelihood of association may be applied to the alert and provided, in addition to the associated classification label and alert, to the action generator 244. In some embodiments the alert analysis and labeling engine 242 may also generate a set of associated alerts related to the received alert. The association may result from the predictive model and/or be associated with correlating meta-information of the alert. The predictive model is generated by the predictive model generation logic 265.

The predictive model generation logic 265 generates predictive models and stores in the memory 230. In some embodiments the predictive model generation logic 265 may generate a separate second predictive action model (based on the actions previously associated with alerts and stored in the knowledge store 140) for use by the action generator 244, distinct and trained separately from the predictive model used by the alert analysis and labeling engine 242 (based on prior classifications of alerts and stored in the knowledge store 140). In other embodiments the predictive model generation logic may associate prior analyzed alerts with the received alert to determine if they are related and may need to be processed by the analyst together. If so, they may be associated together in meta-information and provided to the presentation logic 250. The predictive model generation logic 265 generates models based on information stored in memory 230 related to prior alerts and actions. The predictive model generation logic 265 analyzes stored information to generate a predictive model according to known machine learning techniques. A random forest classifier is an exemplary technique that creates a set of decision trees from randomly selected subset of training set. The random forest classifier then aggregates the decisions from the set of decision trees to decide the final classification associated with the targeted alert. In some embodiments an alternative technique may be used (e.g., convolutional neural networks, support vector machines, etc.). The generated predictive models are stored in memory 230 to be accessed by the analytic logics of the automated analyst recommendation system 200.

The action generator 244 receives from the alert analysis and labeling engine 242 the received alert and at least the classification label(s) determined by the alert analysis and labeling engine. The action generator 244 analyzes the received alert and classification and may determine an action which may be executed in response to the alert. The determined action may be an action recommended (to the analyst) to mitigate the cyber-security threat identified by the alert. In some embodiments the determined action may include instructions to obtain additional information regarding the alert (e.g., an instruction to the alert originating cyber-security device for additional meta-information related to the first alert). The action generator 244 may generate an action based on rules stored in memory 230 and/or based on model provided by the predictive model generation logic 265. The predictive model generation logic 265 may generation a predictive action model in response to storage in memory 230 of new actions. New actions may be stored in memory 230 based on an update action received by the automated analyst recommendation engine via the network interface(s) 220 and/or via analyst selecting a recommended action or submitting an action. The predictive action model is generated based on actions stored in memory 230. The action generator 244 may associate no actions or one or more actions in response to further analysis of the received alert and/or classification information (the classification information including the at least classification label and associated likelihood of association). In some embodiments the action generator 244 determines that a recommended action shall be executed without confirmation by the analyst and the action is labelled with such an indicator. Once the action generator 244 determines whether an action may be associated with the alert, the alert and any associated information is provided to the presentation logic 250.

The presentation logic 250 is provided with the alert from either the alert analysis and labeling engine 242 or the action generator 244 as well as with additional meta-information (e.g., recommended action(s), classification(s) and associated confidence levels) generated during prior processing for presentation to the analyst. If an action is labeled for automatic execution the action is provided to the mitigation logic 252 by the presentation logic 250. Similarly, if responsive to presentation to an analyst, the presentation logic 250 receives instructions from the analyst, the action instructed is provided to the mitigation logic 252 for processing. The presentation logic 250 may further analyze the alert and associated meta-information to determine a priority and arrangement of the alert and associated information to the analyst. For example, alerts associated with low confidence levels (e.g., the system cannot properly label the alert), may be assigned a higher priority and presented to the analyst. In some other embodiments, analysis of the meta-information associated with an alert may indicate duplicative alerts having been received, consequently, the presentation logic may generate a modified GUI to aggregate and/or filter the duplicative alerts to the analyst. In still yet other embodiments the presentation logic 250 may receive from the mitigation logic 252 the results of an executed action for presentation to the analyst and storage by the action logic 260. Upon receipt, the execution results are associated with the associated alert's meta-information and provided to storage logic 260.

The mitigation logic 252 receives action instructions via the presentation logic 250. Actions may be provided to the mitigation logic 252 automatically or in response to an instruction from an analyst. The action may require communication via the network interface(s) 220 to third party systems (e.g., cyber-security devices 102). Communication with third party systems may require authentication credentials for authorization, which may be configured by the security administrator and/or an analyst in advance of action execution or as needed. The mitigation logic 252 may also operate via the analyst alert recommendation system 200 directly. An action execution result may be generated upon receipt of results from an execution. In some embodiments, if no result response is received within a specified time period (e.g., 60 seconds) the mitigation logic may generate an action execution result indicating a “timeout”. The results response is provided to the storage logic 260 via the presentation logic 250.

The storage logic 260 processes the received alert and meta-information (including results information provided by the mitigation logic 252. The storage logic 260 analyzes the alert and associated meta-information and determines if the action and/or classifications may be stored in memory 230. The determination, as to whether or not the meta-information may be stored in memory 230, may be based on the duplicative nature of the meta-information (i.e. determine if the same information is stored in the memory), modification of existing meta-information stored in the memory and/or if the meta-information to be stored is inconsistent with prior stored meta-information.

The reporting engine 254 receives the alert and associated meta-information for presentation to the analyst. The reporting engine may provide the alert and associated meta-information to the user interface 290 and/or to the network device(s) 220 for presentation to the analyst. The user interface 290 may produce a graphical or textual based representation to a user of the endpoint 10 device 200. The user interface 290 provides the user with the ability to interact with the computer. The user interface 290 may not be present for an endpoint device that is not dedicated to a single user or does not require the interaction with a user. The user interface 290 may receive input via the network device(s) 280 which include various input/output devices.

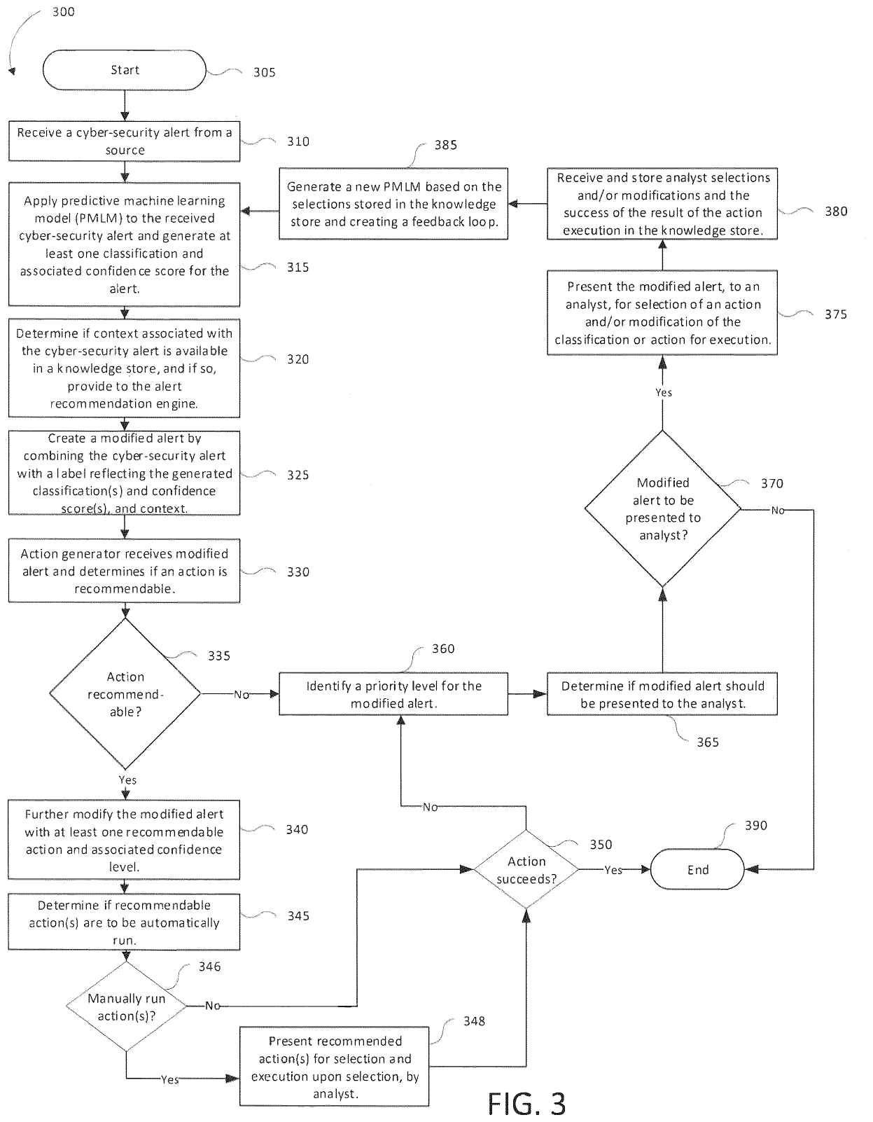

FIG. 3 represents an exemplary flowchart of a computerized method 300 for operating an automated analyst recommendation system 100. The exemplary method 300 starts at step 305 and proceeds to step 310 where the automated analyst recommendation system 100 receives an alert from cyber-security device(s) 102 transmitted over the communication network 105 via the network interface(s) 110. During step 310, the alert parser 120 processes the alert to generate processible meta-information for further analysis by subsequent analytics logics (e.g., the alert analysis and labeling engine 132, the action generator 134, etc.). Upon completion of processing by the alert parser 120, the alert and associated meta-information is provided to alert analysis and labeling engine 132 for further analysis in step 315.

The alert analysis and labeling engine 132, during step 315 applies the predictive machine learning model stored in the knowledge store 140, to the received alert and associated meta-information. The results of the analysis of the received alert and meta-information with the predictive model is at least one classification label and a confidence level (e.g., likelihood of association, etc.). In some embodiments the predictive model may also generate a set of alerts associated as meta-information with the received alert. The associated alerts may be relevant to the assessment of the received alert when reviewed by an analyst. If associated alerts are identified, the alert and associated meta-information is retrieved from the knowledge store 140 and added to the received alert's associated meta-information for further processing in step 320. In step 325 the meta-information and the received alert are associated and provided to the action generator 134 for further analysis.

In step 330 the action generator 134 receives the alert received by the automated analyst recommendation system 100 and associated meta-information for analysis. The analysis may include the processing of factory-set and/or user-defined rules. For example, an alert associated with a “phishing” email cyberattack may identify the source cyber-security device(s) 102 from the meta-information and generate an action targeting the phishing email for quarantine. In some embodiments a predictive action model may be applied to the received alert and meta-information to generate a set of recommended actions based on prior actions taken and/or recorded by the automated analyst recommendation system 100. If an action is generated in step 335, the method continues step 340 where the alert and its associated meta-information is modified with the generated action(s). Further processing by the action generator 134 may further determine if at least one of the generated action(s) should be automatically processed by the mitigation logic 170 in step 345. If the generated action is determined to be automatically run in step 350, and succeeds, the method ends at step 390. If the generated action is determined to be manually run in step 345, the generated action is presented to the analyst via the analyst interface 195 in step 348. Upon selection by the analyst, the analyst interface 195 provides the selection to the mitigation logic for execution and if in step 350 the executed action succeeds, the method ends at step 390.

If the action generator cannot identify a recommendable action in step 335 or the executed action fails in step 350, the presentation logic 160 determines a priority for presentation of the alert to the analyst in step 360. The determination of priority is based, at least in part, on the success of an action executed by the mitigation logic 170. In some embodiments, the priority for presentation of an alert to the analyst may be based on the confidence level associated with a classification of the alert. In some embodiments, the presentation logic 160 determines a priority level of an alert in step 360 then in step 365 determines if the alert, based in part on the priority level, should be presented to the analyst. If the presentation logic 160 determines that the alert need not be presented to the analyst in step 370, the method ends at step 390.

If the alert is determined to be presented to the analyst in step 370 by the presentation logic 160, the alert is presented to the analyst for further interaction. In some embodiments the further interaction with the analyst may be done through a user interface 290 or via the reporting engine 190 once the alert has been further processed by the storage logic 180. In step 375 the analyst is presented with the modified alert. The analyst may select an action associated with the modified alert, modify a classification of the modified alert, and/or generate an action or classification associated with the alert based on the context received. The result of step 375 is provided to the knowledge store via the storage logic 180 in step 380. In step 380, upon receipt of a new and/or modified alert and/or action result, the storage logic 180 may store the received information in the knowledge store 140. If information received by the knowledge store in step 380, the alert analysis and labeling engine 132 may regenerate a new predictive model based on the new information and re-analyze the received alert in step 385. By this method, the system will identify alerts requiring additional action by an analyst while minimizing the time spent by analysts on low value alerts.

The foregoing description has been directed to specific embodiments. It will be apparent, however, that other variations and modifications may be made to the described embodiments, with the attainment of some or all their advantages. For instance, it is expressly contemplated that the components and/or elements described herein can be implemented as software encoded on a tangible (non-transitory) computer-readable medium (e.g., disks, electronic memory, and/or CDs) having program instructions executing on a computer, hardware, firmware, or a combination thereof. Moreover, the embodiments or aspects thereof can be implemented in hardware, firmware, software, or a combination thereof. In the foregoing description, for example, in certain situations, terms such as “engine,” “component” and “logic” are representative of hardware, firmware and/or software that is configured to perform one or more functions. As hardware, engine (or component/logic) may include circuitry having data processing or storage functionality. Examples of such circuitry may include, but is not limited or restricted to a microprocessor, one or more processor cores, a programmable gate array, a microcontroller, an application specific integrated circuit, semiconductor memory, or combinatorial logic. Accordingly, this description is to be taken only by way of example and not to otherwise limit the scope of the embodiments herein. Therefore, it is the object of the appended claims to cover all such variations and modifications as come within the true spirit and scope of the invention.

What is claimed is:

1. A computer-implemented method for improving a predictive machine learning model of a cyber-security alert system, the method comprising:
receiving, by a computing system, a cyber-security alert;
classifying, by the computing system, the received alert according to the predictive machine learning model to generate a classification;
causing, by the computing system, the classification to be displayed to a cyber-security analyst for review;
receiving, by the computing system from the cyber-security analyst, a classification from the analyst for the cyber-security alert, wherein the classification from the analyst is a confirmation or a reclassification of the classification generated by the computing system;
updating, by the computing system, a knowledge store to include an association between the cyber-security alert and the classification from the analyst; and
generating, by the computing system, a new predictive model based on the updated knowledge store to implement a self-learning feedback loop.

2. The computer-implemented method of claim 1, wherein the classification generated by the computing system is associated with a confidence level, and wherein the method further comprises causing the confidence level to be displayed to the cyber-security analyst.

3. The computer-implemented method of claim 2, further comprising:
determining whether the confidence level satisfies a confidence threshold; and
wherein causing the classification generated by the computing system to be displayed is performed only when the confidence level fails to satisfy the confidence threshold.

4. The computer-implemented method of claim 1, wherein the reclassification of the classification generated by the computing system comprises the cyber-security analyst modifying a label associated with the received alert.

5. The computer-implemented method of claim 1, further comprising:
receiving, from the cyber-security analyst, a selection of a course of action associated with the cyber-security alert; and
updating the knowledge store to include the selected course of action.

6. The computer-implemented method of claim 5, further comprising:
identifying a newly received alert having features similar to the cyber-security alert; and
recommending the selected course of action for the newly received alert.

7. The computer-implemented method of claim 1, wherein generating the new predictive model is performed in response to the knowledge store being updated with the classification from the analyst.

8. The computer-implemented method of claim 1, wherein generating the new predictive model comprises training the predictive machine learning model using the updated knowledge store.

9. The computer-implemented method of claim 1, wherein the predictive machine learning model used to generate the classification comprises an artificial neural network.

10. A computing system configured to implement a self-learning feedback loop for a cyber-security alert system, the computing system comprising:
one or more processors; and
one or more non-transitory computer-readable media that collectively store instructions that, when executed by the one or more processors, cause the computing system to perform operations, the operations comprising:
classifying a received cyber-security alert according to a predictive machine learning model to generate a classification;
causing the classification to be displayed to a cyber-security analyst for review;
receiving, from the cyber-security analyst, a classification from the analyst for the cyber-security alert, wherein the classification from the analyst is a confirmation or a reclassification of the classification generated by the predictive machine learning model;
updating a knowledge store to include an association between the cyber-security alert and the classification from the analyst; and
generating a new predictive model based on the updated knowledge store.

11. The computing system of claim 10, wherein the classification generated by the predictive machine learning model is associated with a confidence level, and wherein the operations further comprise causing the confidence level to be displayed to the cyber-security analyst.

12. The computing system of claim 10, wherein the reclassification of the classification generated by the predictive machine learning model comprises the cyber-security analyst modifying a label associated with the received alert, and wherein the knowledge store is updated to include the modified label.

13. The computing system of claim 10, wherein the operations further comprise:
receiving, from the cyber-security analyst, a selection of a course of action; and
updating the knowledge store to include the selected course of action in association with the cyber-security alert.

14. The computing system of claim 10, wherein causing the classification generated by the predictive machine learning model to be displayed comprises presenting, via a graphical user interface, the classification and one or more user-selectable options for providing the classification from the analyst.

15. The computing system of claim 10, wherein the predictive machine learning model used to generate the classification comprises an artificial neural network.

16. One or more non-transitory computer-readable media that collectively store instructions that, when executed by one or more processors of a computing system, cause the computing system to improve a predictive machine learning model by performing operations comprising:
classifying a received cyber-security alert according to the predictive machine learning model to generate a classification;
causing the classification to be displayed to a cyber-security analyst for review;
receiving, from the cyber-security analyst, a classification from the analyst for the cyber-security alert, wherein the classification from the analyst is a confirmation or a reclassification of the classification generated by the predictive machine learning model;
updating a knowledge store to include an association between the cyber-security alert and the classification from the analyst; and
generating a new predictive model based on the updated knowledge store.

17. The one or more non-transitory computer-readable media of claim 16, wherein the classification generated by the predictive machine learning model is associated with a confidence level, and wherein the operations further comprise causing the confidence level to be displayed to the cyber-security analyst.

18. The one or more non-transitory computer-readable media of claim 16, wherein the reclassification of the classification generated by the predictive machine learning model comprises modifying a label associated with the received alert.

19. The one or more non-transitory computer-readable media of claim 16, wherein the operations further comprise:
receiving, from the cyber-security analyst, a selection of a course of action associated with the cyber-security alert; and
updating the knowledge store to include the selected course of action.

20. The one or more non-transitory computer-readable media of claim 16, wherein generating the new predictive model is performed periodically.
